(19) United States
(12) Patent Application Publication
(10) Pub. No.: US 2005/0028664 A1
(43) Pub. Date: Feb. 10, 2005

(54) Disk cutter

(75) Inventors: Noriyuki Terada, Iwata-gun (JP); Takehide Iguchi, Iwata-gun (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: TENRYU SEIKYO KABUSHIKI KAISHA, Iwata-gun (JP)

(21) Appl. No.: 10/900,285

(22) Filed: Jul. 28, 2004

(30) Foreign Application Priority Data
Aug. 8, 2003 (JP) 2003-290457

(51) Int. Cl. B23D 57/00

(52) U.S. Cl. 83/835

(57) ABSTRACT

A disk cutter including an annular disk-shaped base adapted to be driven about an axis of rotation, a plurality of tip supports formed along the outer circumference of the base integrally therewith so that a gullet is defined between adjacent ones of the tip supports, and a plurality of sets of tip inserts respectively fixed to the tip supports. Each set of tip inserts includes a pair of inclined tip inserts having oppositely inclined flanks with the same transverse clearance angle and oppositely inclined rakes with the same transverse rake angle. Each inclined tip insert has an inclined cutting edge such that a leading corner in respect of rotation of the base is lower in level than a trailing corner. The amount of sideward projection of the leading corner from the surface of the corresponding tip support is set larger by a given amount than that of the trailing corner.

### BACKGROUND OF THE INVENTION

1. Field of the Invention

The present invention relates generally to a disk cutter, and more particularly to a disk cutter or circular saw suitable for cutting of a brittle board, e.g., a board formed of hard plastic.

2. Description of the Related Art

A disk cutter or tip saw including a base disk having a plurality of tip supports arranged along the outer circumference and a plurality of hardened cutting tip inserts (cutter inserts) respectively fixed to the tip supports by brazing or the like is frequently used for board cutting or the like. The tip supports are spaced at given intervals in the circumferential direction of the base disk or annular disk-shaped base, and a gullet (chip space) is defined between adjacent ones of the tip supports. Each tip support has a recess, and each cutting tip insert is fixed in the recess of the corresponding tip support by brazing or the like. The base disk has a first mounting hole at its central portion, and a boss portion of a collar is inserted through the first mounting hole. The boss portion of the collar is formed with a second mounting hole, and a rotating shaft of a rotary tool is inserted through the second mounting hole. The disk cutter is mounted to the rotary tool by fastening the base disk through the collar to the rotating shaft with a bolt.

Examples of the cutting tip insert include a plain tip insert having a cutting edge whose height is uniform, an inclined tip insert having a rake inclined at a given transverse rake angle and a flank inclined at a given transverse clearance angle, and a tip insert having a triangular or trapezoidal cutting edge. Of these kinds of tip inserts, the inclined tip insert is generally used for cutting of a board formed of hard plastic.

A conventional disk cutter having inclined tip inserts and plain tip inserts fixed to tip supports will now be described with reference to FIGS. 1 to 3. The disk cutter 2 has a circular base disk or annular disk-shaped base 4. The base disk 4 has a plurality of tip supports 6 arranged along the outer circumference so as to be spaced at given intervals in the circumferential direction of the base disk 4, thereby defining a gullet 7 between adjacent ones of the tip supports 6. Each tip support 6 has a recess, and a plurality of sets of tip inserts are fixed in the recesses of the tip supports 6. Each set of tip inserts is composed of a first inclined tip insert 8, a second inclined tip insert 10, and a plain tip insert 12.

As shown in FIGS. 2 and 3, the first and second tip inserts 8 and 10 in each set of tip inserts have oppositely inclined flanks with the same transverse clearance angle D and oppositely inclined rakes with the same transverse rake angle B. As shown in FIG. 3, the first inclined tip insert 8 has an inclined cutting edge such that a leading corner 8a in respect of rotation of the base disk 4 is higher in level than a trailing corner 8b. Similarly, the second inclined tip insert 10 has an inclined cutting edge such that a leading corner 10a in respect to rotation of the base disk 4 is higher in level than a trailing corner 10b. Further, the amount of sideward projection of the leading corner 8a from the surface of the corresponding tip support 6 is set larger by a given amount (L) than that of the trailing corner 8b. Similarly, the amount of sideward projection of the leading corner 10a from the surface of the corresponding tip support 6 is set larger by L than that of the trailing corner 10b. Further, the plain tip insert 12 in each set of tip inserts has a cutting edge lower in level by a given amount than the leading corner 8a of the cutting edge of the first inclined tip insert 8. Similarly, the cutting edge of the plain tip insert 12 is lower in level by the given amount than the leading corner 10a of the cutting edge of the second inclined tip insert 10. Further, the transverse length of the cutting edge of the plain tip insert 12 is set slightly smaller than the transverse distance between the leading corners 8a and 10a of the inclined tip inserts 8 and 10.

In the. conventional disk cutter 2 mentioned above, the leading corners 8a and 10a of the cutting edge of the inclined tip inserts 8 and 10 are located at the transversely outermost positions in the inclined tip inserts 8 and 10. Further, the leading corners 8a and 10a are higher in level than the trailing corners 8b and 10b, and are acute in corner angle. Accordingly, the cutting ridge by the leading corners 8a and 10a is long, so that a large shock occurs in a workpiece. As a result, in cutting a board formed of hard plastic or a board (decorative laminate) having a surface to which a hard decorative film is fixed, there arises a problem of edge chipping or cracking on the cut surface of the board. Further, the cut surface becomes rough.

### SUMMARY OF THE INVENTION

It is therefore an object of the present invention to provide a disk cutter which can cut a board formed of hard plastic or a board (decorative laminate) having a surface to which a hard decorative film is fixed, without the occurrence of edge chipping or cracking on the cut surface of the board.

In accordance with an aspect of the present invention, there is provided a disk cutter comprising an annular disk-shaped base adapted to be driven about an axis of rotation; a plurality of tip supports formed along the outer circumference of the base integrally therewith so that a gullet is defined between adjacent ones of the tip supports; and a plurality of sets of tip inserts respectively fixed to the tip supports; each of the plurality of sets of tip inserts including a pair of inclined tip inserts having oppositely inclined flanks with the same transverse clearance angle and oppositely inclined rakes with the same transverse rake angle; each of the inclined tip inserts having an inclined cutting edge such that a leading corner in respect of rotation of the base is lower in level than a trailing corner; the amount of sideward projection of the leading corner from the surface of the corresponding tip support being set larger by a given amount than that of the trailing corner.

Preferably, the transverse clearance angle and the transverse rake angle of each inclined tip insert are set in the range of 3° to 15°, more preferably in the range of 5° to 10°, and the given amount is set in the range of 0.005 mm to 0.04 mm.

In accordance with another aspect of the present invention, there is provided a disk cutter comprising an annular disk-shaped base adapted to be driven about an axis of rotation; a plurality of tip supports formed along the outer circumference of the base integrally therewith so that a gullet is defined between adjacent ones of the tip supports; and a plurality of sets of tip inserts respectively fixed to the tip supports; each of the plurality of sets of tip inserts comprising at least one pair of inclined tip inserts and one plain tip insert; the pair of inclined tip inserts having oppositely inclined flanks with the same transverse clearance angle and oppositely inclined rakes with the same transverse rake angle; each of the inclined tip inserts having an inclined cutting edge such that a leading corner in respect of rotation of the base is lower in level than a trailing corner; the amount of sideward projection of the leading corner from the surface of the corresponding tip support being set larger by a given amount than that of the trailing corner.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a side view of a part of a conventional disk cutter;

FIG. 2 is a plan view of FIG. 1;

FIG. 3 is a view taken in the direction of arrow III in FIG. 1;

FIG. 4 is a side view of a part of a disk cutter according to a preferred embodiment of the present invention;

FIG. 5 is a plan view of FIG. 4;

FIG. 6 is a view taken in the direction of arrow VI in FIG. 4;

FIG. 7 is an enlarged side view of a tip support to which an inclined tip insert is fixed;

FIG. 8 is a view taken in the direction of arrow VIII in FIG. 7; and

FIG. 9 is a view taken in the direction of arrow IX in FIG. 7.

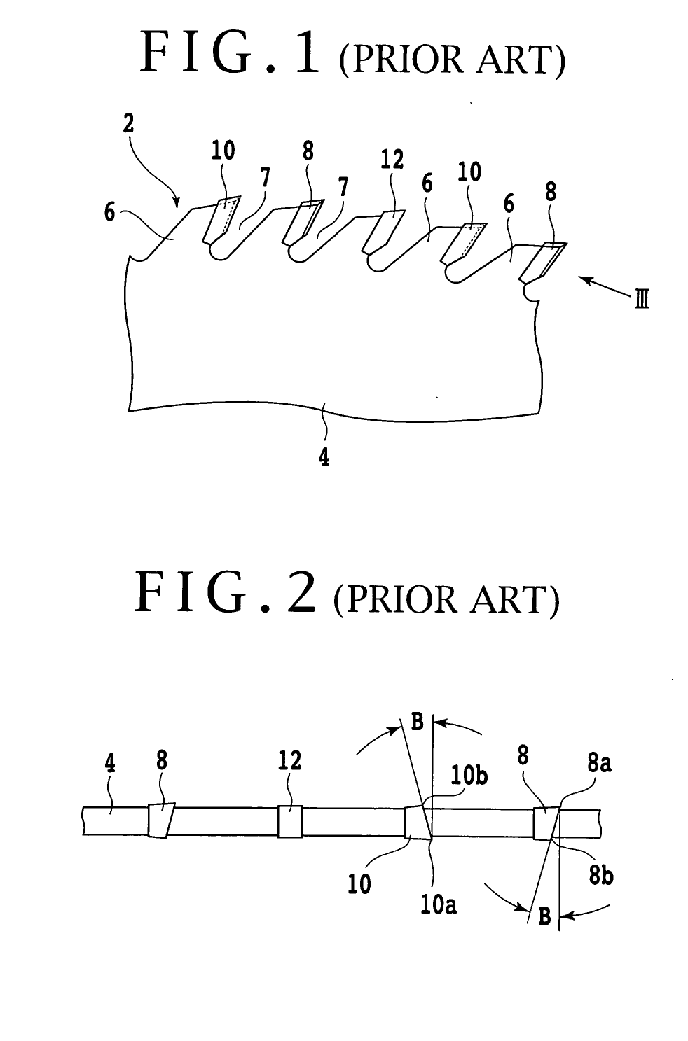

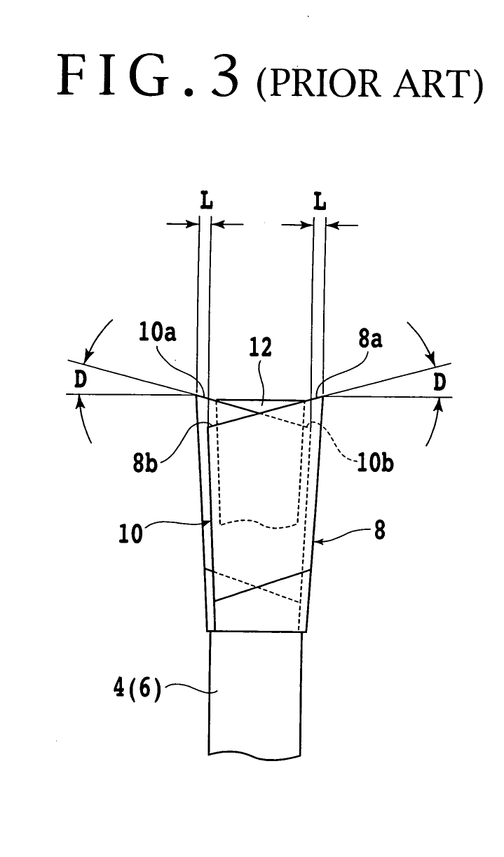

### DETAILED DESCRIPTION OF THE PREFERRED EMBODIMENTS

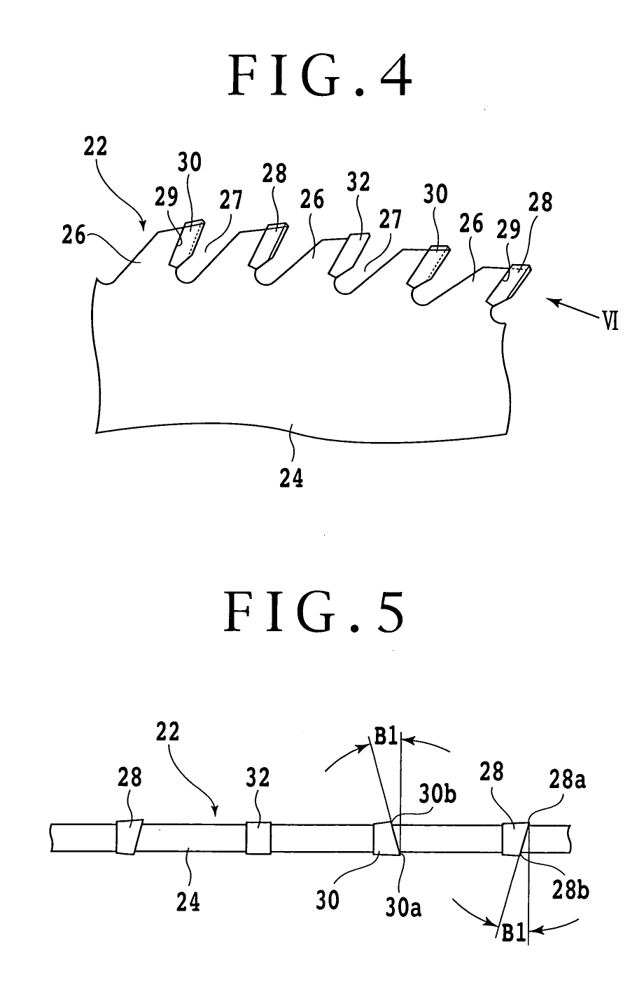

Referring now to FIG. 4, there is shown a side view of a part of a disk cutter 22 according to a preferred embodiment of the present invention. FIG. 5 is a plan view of FIG. 4. The disk cutter 22 is formed suitably for cutting of a board formed of hard plastic or a board (decorative laminate) having a surface to which a hard decorative film is fixed. In this preferred embodiment, the disk cutter 22 includes an annular disk-shaped base (base disk) 24 having a thickness of about 1.2 mm and a plurality of (e.g., 24) saw-toothed tip supports 26 formed along the outer circumference of the base disk 24 at equal intervals or unequal intervals. A gullet 27 is defined between adjacent ones of the tip supports 26. The base disk 24 is formed of steel such as JIS SKS51 (alloy tool steel), JIS SK5 (carbon tool steel), or JIS SK6 (carbon tool steel).

Each tip support 26 is formed with a recess 29, and a plurality of sets of tip inserts 28, 30, and 32 are fixed in the recesses 29 by brazing or the like. That is, each set of tip inserts 28, 30, and 32 is composed of a pair of first and second inclined tip inserts 28 and 30 and one plain tip insert 32. The first and second inclined tip inserts 28 and 30 have oppositely inclined flanks with the same transverse clearance angle D1 and oppositely inclined rakes with the same transverse rake angle B1. Thus, the plural sets of tip inserts 28, 30, and 32 are fixed to the tip supports 26. The first and second inclined tip inserts 28 and 30 and the plan tip insert 32 constituting each set of tip inserts are formed of a greatly hard material such as cemented carbide as specified by JIS K10 or K20.

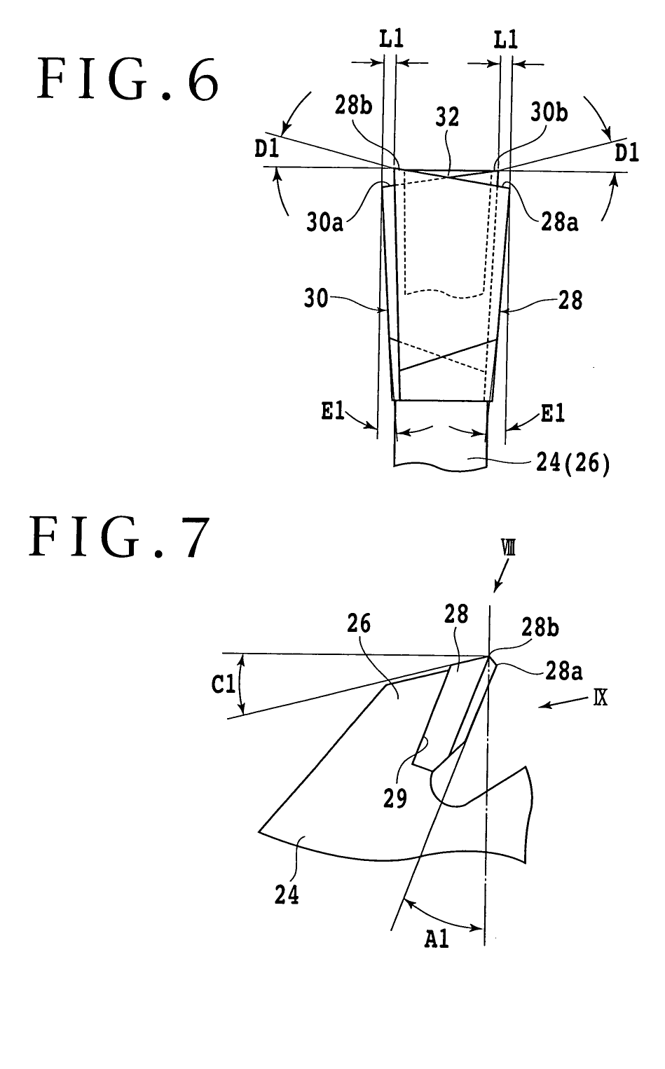

As shown in FIG. 6, the first inclined tip insert 28 has an inclined cutting edge such that a leading corner 28a in respect of rotation of the base disk 24 is lower in level than a trailing corner 28b Similarly, the second inclined tip insert 30 has an inclined cutting edge such that a leading corner 30a in respect of rotation of the base disk 24 is lower in level than a trailing corner 30b. Further, the amount of sideward projection of the leading corner 28a from the surface of the corresponding tip support 26 is set larger by L1 than that of the trailing corner 28b Similarly, the amount of sideward projection of the leading corner 30a from the surface of the corresponding tip support 26 is set larger by L1 than that of the trailing corner 30b. In this preferred embodiment, L1 is set in the range of 0.005 mm to 0.04 mm.

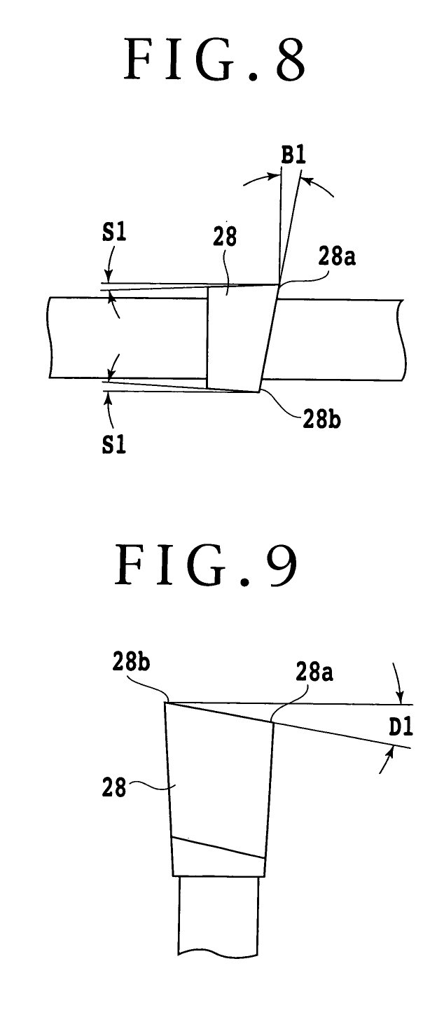

As shown in FIGS. 5 and 6, the transverse clearance angle D1 and the transverse rake angle B1 of each of the first and second inclined tip inserts 28 and 30 are set in the range of 30° to 15°, preferably 5° to 10°. As shown in FIG. 7, the rake angle A1 is set in the range of 10° to 20°, and the clearance angle C1 is set in the range of 5° to 15°. As shown in FIG. 6, the side centripetal angle E1 is set in the range of 0.5° to 2°. As shown in FIG. 8, the side clearance angle S1 is set in the range of 1° to 4°. The plain tip insert 32 has a cutting edge slightly lower in level than the trailing corner 28b of the cutting edge of the first inclined tip insert 28. Similarly, the cutting edge of the plain tip insert 32 is slightly lower in level than the trailing corner 30b of the cutting edge of the second inclined tip insert 30. Further, the transversely opposite ends of the cutting edge of the plain tip insert 32 are located by about 0.2 mm transversely inside of the trailing corners 28b and 30b of the first and second inclined tip inserts 28 and 30.

According to this preferred embodiment, in rotating the disk cutter 22 to cut a workpiece, the trailing corners 28b and 30b of the cutting edges of the first and second inclined tip inserts 28 and 30, which corners 28b and 30b are higher in level and acute in corner angle, cut the inside of a cut surface, and the leading corners 28a and 30a obtuse in corner angle cut the opposite sides of the cut surface. Accordingly, the cutting ridge by the leading corners 28a and 30a of the cutting edges can be shortened. Furthermore, since each of the leading corners 28a and 30a of the inclined tip inserts 28 and 30 has a transverse rake angle B1 of 3° to 15°, the leading corners 28a and 30a cut the opposite sides of the cut surface so as to inward attract them. Accordingly, the shock occurring in cutting the opposite sides of the cut surface can be reduced to thereby prevent the edge chipping or cracking on the cut surface.

Further, the plain tip insert 32 is present transversely inside of the trailing corners 28b and 30b in each set of tip inserts, and the plain tip insert 32 therefore cuts the inside of the cut surface. Accordingly, the cutting ridge by the trailing corners 28b and 30b of the inclined tip inserts 28 and 30 can also be shortened to thereby further reduce the shock occurring in cutting. As a result, the edge chipping or cracking on the cut surface can be prevented. In particular, a board (decorative laminate) having a surface to which a hard decorative film such as a melamine resin film is fixed can be smoothly cut.

It should be noted that each set of tip inserts is not limited to the two inclined tip inserts 28 and 30 and the one plain tip insert 32 as described above, but various modifications may be made. For example, each set of tip inserts may be composed of four inclined tip inserts 28 and 30 alternately arranged and one plain tip insert 32.

The present invention is not limited to the details of the above described preferred embodiments. The scope of the invention is defined by the appended claims and all changes and modifications as fall within the equivalence of the scope of the claims are therefore to be embraced by the invention.

1. A disk cutter comprising:
an annular disk-shaped base adapted to be driven about an axis of rotation;
a plurality of tip supports formed along the outer circumference of said base integrally therewith so that a gullet is defined between adjacent ones of said tip supports; and
a plurality of sets of tip inserts respectively fixed to said tip supports;
each of said plurality of sets of tip inserts including a pair of inclined tip inserts having oppositely inclined flanks with the same transverse clearance angle and oppositely inclined rakes with the same transverse rake angle;
each of said inclined tip inserts having an inclined cutting edge such that a leading corner in respect of rotation of said base is lower in level than a trailing corner;
the amount of sideward projection of said leading corner from the surface of said corresponding tip support being set larger by a given amount than that of said trailing corner.

2. A disk cutter according to claim 1, wherein said transverse clearance angle and said transverse rake angle of each inclined tip insert are set in the range of 3° to 15°, and said given amount is set in the range of 0.005 mm to 0.04 mm.

3. A disk cutter comprising:
an annular disk-shaped base adapted to be driven about an axis of rotation;
a plurality of tip supports formed along the outer circumference of said base integrally therewith so that a gullet is defined between adjacent ones of said tip supports; and
a plurality of sets of tip inserts respectively fixed to said tip supports;
each of said plurality of sets of tip inserts comprising at least one pair of inclined tip inserts and one plain tip insert;
said pair of inclined tip inserts having oppositely inclined flanks with the same transverse clearance angle and oppositely inclined rakes with the same transverse rake angle;
each of said inclined tip inserts having an inclined cutting edge such that a leading corner in respect of rotation of said base is lower in level than a trailing corner;
the amount of sideward projection of said leading corner from the surface of said corresponding tip support being set larger by a given amount than that of said trailing corner.

4. A disk cutter according to claim 3, wherein said transverse clearance angle and said transverse rake angle of each inclined tip insert are set in the range of 3° to 15°, and said given amount is set in the range of 0.005 mm to 0.04 mm.
